(19) United States
(12) Patent Application Publication
(10) Pub. No.: US 2022/0301735 A1
(43) Pub. Date: Sep. 22, 2022

(54) METHOD FOR PRODUCING 225ACTINIUM FROM 226RADIUM

(71) Applicant: THE EUROPEAN UNION, REPRESENTED BY THE EUROPEAN COMMISSION, Brussels (BE)

(72) Inventors: Rikard MALMBECK, Karlsruhe (DE); Roberto CACIUFFO, Torino (IT); Nidhu Lal BANIK, Stutensee (DE)

(73) Assignee: THE EUROPEAN UNION, REPRESENTED BY THE EUROPEAN COMMISSION, Brussels (BE)

(21) Appl. No.: 17/612,602

(22) PCT Filed: Jun. 22, 2020
(86) PCT No.: PCT/EP2020/067376

§ 371 Date: Nov. 19, 2021

(30) Foreign Application Priority Data
Jun. 25, 2019 (EP) 19182228.7

(51) Int. Cl. G21G 1/00; G21G 1/10; G21G 1/12

(52) U.S. Cl. CPC G21G 1/001; G21G 1/10; G21G 1/12; G21G 2001/0089

(57) ABSTRACT

²²⁵actinium is produced from ²²⁶radium by irradiating a liquid ²²⁶radium target by means of protons, deuterons or gamma irradiation in an irradiation device (2) and by extracting the produced ²²⁵actinium out of the irradiated liquid target solution in a first extraction device (6). The liquid target solution from which the ²²⁵actinium has been removed is then irradiated again to produce further ²²⁵actinium therein. The liquid target solution is preferably circulated, in a closed loop (4), over the irradiation device and in a further closed loop (7) over the first extraction device (6). An advantage of such a method is that the irradiated target solution does not need to be dried and re-dissolved to be able to separate the produced actinium from the radium and no further drying and re-dissolving step is needed for producing the liquid target again starting from the separated radium. The radium target can thus be recycled in a more efficient and safer way, especially in view of the radon gas which is continuously produced by the decay of ²²⁶radium.

The present invention relates to a method for producing ²²⁵actinium from ²²⁶radium, wherein a liquid target solution containing ²²⁶radium is provided, wherein said liquid target solution is irradiated in an irradiation device to produce ²²⁵actinium in the liquid target solution starting from the ²²⁶radium contained therein; and wherein at least part of the produced ²²⁵actinium is separated from the remaining ²²⁶radium.

²²⁵Actinium is an interesting radionuclide for use in cancer treatment. ²²⁵Actinium is an a-emitting radioisotope with a 10 day half-life. It can be used as an agent for radio-immunotherapy. α-particle emitters are a promising source for lethal irradiation of single cancer cells and micro-metastases because of their densely ionizing radiation. α-particles are of considerable interest for radio-immunotherapy applications since their range in soft tissue is limited to only a few cell diameters.

There are a number of possible methods for producing ²²⁵actinium but there is still a need for a new, safer production method which enables to produce the ²²⁵actinium in the quantities required to meet the demands.

As disclosed for example in U.S. Pat. No. 5,809,394 ²²⁵actinium can be produced through the radioactive decay of ²²⁹thorium. This is the current main method to produce ²²⁵Ac for medical applications. This method utilises the ²²⁹Th/²²⁵Ra/²²⁵Ac generator (Boll 2005) wherein ²²⁵Ac is constantly produced by radioactive ingrowth from the alpha decay of ²²⁹Th and its daughter ²²⁵Ra. The generator produces radiochemically pure ²²⁵Ra and ²²⁵Ac, every 6 to 8 weeks. The maximum activity of ²²⁵Ac is limited to the total amount of ²²⁹Th present in the generator. The chemical separation between ²²⁹Th and ²²⁵Ra/²²⁵Ac is normally based on ion exchange. At present three such generators exist in the world. ORNL (USA) is supplying up to 720 mCi per year of ²²⁵Ac. A similar quantity is reported to be available from the Institute of Physics and Power Engineering, in Obninsk, Russia and European Commission directorate G, site Karlsruhe maintains a smaller ²²⁹Th source that is capable of producing up to 350 mCi of ²²⁵Ac per year. The problem is, however, that the demand of ²²⁵Ac is already higher than the total production rate from the existing generators. ²²⁹Th on the other hand, is a rare isotope (originating from ²³³U) and has a limited availability in the world. Due to the long half-life of ²³³U and ²²⁹Th, it is not likely that the inventory of ²²⁹Th can be significantly increased, even though production methods are being investigated (Jost 2013).

Another method for producing ²²⁵actinium consists in the production of ²²⁵Ac by proton or deuteron irradiation of ²³²thorium targets. This method is based on the manufacturing of thick ²³²Th metal targets (natural Th) which are irradiated with medium energy protons or deuterons (24-50 MeV) (Morgenstern 2006) by a cyclotron or medium to high energy protons (>80 MeV) in an accelerator facility (Ermalaev 2012, Weidner 2012). With medium energy protons or deuterons the ²²⁵Ac production is based on ²³²Th(p,4n)²²⁹Pa and ²³²Th(d,5n)²²⁹Pa with a subsequent low yield 0.48% β⁺ decay into isotopically pure ²²⁵Ac. The required proton and deuteron energies are in the range of today's commercial cyclotrons but very high currents are needed to yield interesting production rates. The direct production of ²²⁵Ac through ²³²Th(p,x) reactions of high energy protons are not sensitive to the production of ²²⁵Ac only and neighbouring isotopes will be produced with comparable high cross-sections. In fact, Ci levels ²²⁵Ac can be produced by high energy protons in a one week irradiation (Ermolaev 2012, Griswold 2016), although the direct therapeutic use might be hampered by co-production of ²²⁷Ac which is a long-lived (27 years) alpha emitter (Ermolaev 2012), produced in an activity ratio ²²⁷Ac/²²⁵Ac=0.2% (Griswold 2016). The chemical separation of actinium from an irradiated thorium target, due to the complex isotopic mixture after irradiation, is fairly complicated and is normally based on a series of ion exchange columns. The separation and purification of ²²⁵Ac from ²²⁷Ac, if necessary, is an isotope separation and cannot be accomplished using ordinary chemical methods. It requires a highly complicated mass separation which can be carried out on-line during the irradiation (ISOLDE). The required proton current (>100 uA) and high proton energy (90-200 MeV) is beyond current commercial cyclotrons. There are in fact only a limited number of accelerator facilities in the world that are capable to produce protons with medium to high energy with the required intensity (Zhuikov 2011). Even less of them are capable to carry out isotope separation on-line.

Another method for producing ²²⁵actinium is for example disclosed in EP 0 752 709 B1 and in EP 0 962 942 B1 and consists in the production of ²²⁵Ac by proton or deuteron irradiation of ²²⁶Ra. The method is based on the manufacturing of thin solid targets of ²²⁶Ra which are placed in a gas tight water cooled target holder and irradiated with protons (Koch 1999, Apostolidis 2004) or deuterons (Abbas 2004). After chemical separation of ²²⁵Ac, the remaining ²²⁶Ra is reprocessed and recycled for production of new targets and thereby closing the radium irradiation cycle. The irradiation method was successfully proven in cyclotron irradiation tests in which mCi levels of ²²⁵Ac was produced. A cross-section of 0.71 mb could be demonstrated at 16.8 MeV protons for the ²²⁶Ra(p,2n)²²⁵Ac reaction and it was further demonstrated through target dissolution and chemical separation that the ²²⁵Ac product was of the same high radiochemical quality as ²²⁵Ac produced from the ²²⁹Th/²²⁶Ra/²²⁵Ac generator. (Apostolidis 2005).

However, further development and demonstration of this method came to a halt due to the complicated handling of a ²²⁶Ra solution. ²²⁶Ra is a fairly long lived alpha emitter, is strongly radioactive and there is a requirement of shielding even when using relatively small amounts. However, the main problem is the presence of ²²²Rn (radon) directly produced in the alpha decay of ²²⁶Ra. In fact, if radon is not constantly separated and removed, ²²⁶Ra and ²²²Rn will after a few weeks reach radioactive equilibrium in which they will have the same activity level. Radon (²²²Rn)) imposes a serious problem as it is a noble gas and thereby very difficult to contain. Handling of large amounts of ²²⁶Ra thus requires under-pressurised shielded facilities such as hot cells and glove boxes with large ventilation flows and a very careful and well thought through handling approach to minimise radium contamination and/or radon emission. The dissolution of the solid irradiated ²²⁶Ra target, the chemical purification of ²²⁵Ac and reprocessing of ²²⁶Ra as well as target production are all open processes which makes the overall process sensitive to radon emission.

Especially critical in such a process is the target handling as the irradiation takes usually place outside a hot cell/glove box. The target, after loading, must be contamination free and gas tight. The water cooling of the target and the thin target window must be optimised for the proton current used in order to avoid target failure. A big advantage with this method is that commercially available cyclotrons intended for production of PET isotopes by proton irradiation can be used. They are capable to deliver the optimised proton energy with a suitable current. However, due to the above described drawbacks the further development of this interesting ²²⁵Ac production method was halted.

Another method for producing ²²⁵Actinium, which has however the same disadvantages as the previous production method, is disclosed for example in US 2002/0094056 A1. This method consists in the production of ²²⁵Ac by irradiation of ²²⁶Ra with neutrons or with high intensity gamma irradiation (which is achieved in US 2002/0094056 A1 by an electron beam which is converted into gamma radiation by the use of a converting material). It utilises the (γ,n) or (n,2n) reaction of ²²⁶Ra to produce ²²⁵Ra which decays into ²²⁵Ac. The photon reaction (γ,n) makes use of an intense field of hard gamma rays, produced as bremsstrahlung in electron accelerators, whereas neutrons are generated in fast reactors or by spallation sources in accelerator facilities. An 18 MV linac, linear (medical) accelerator, was used to produce ²²⁵Ac from ²²⁶Ra but the cross-sections were rendered too small for practical use (Melville 2007). In a later work it was stated that more intense accelerator irradiation of larger amounts of ²²⁶Ra could be feasible (Melville 2009) method. In terms of radium handling, this production method suffers from the same disadvantages as proton irradiation of solid Ra targets. ²²⁶Ra targets must indeed be manufactured, irradiated, dissolved, the actinium product separated and the radium reprocessed for new target production. It is likely that very large (tens of grams or more) ²²⁶Ra targets are needed but in comparison to proton irradiation, the target technology and irradiation is probably technically easier as heat removal is less of an issue and the target window does not have to be thin. Nevertheless, photon or neutron reactions will require large facilities such as a nuclear reactor, a high intensity linear accelerator or a synchrotron to reach suitable production levels.

In summary, the current production method of ²²⁵Ac as decay product from ²²⁹Th cannot easily be increased or scaled up to meet future demands in therapeutic treatments. Actinium can be produced in commercially available cyclotrons by irradiation of radium through the (p,2n) reaction. However, the handling of ²²⁶Ra is very challenging, because of its daughter radon. The suggested technology is based on cyclotron (proton or deuteron) or synchrotron (gamma) irradiation of solid targets and requires target manufacturing, irradiation, target dissolution, actinium separation and finally reprocessing of Ra into new solid targets to close the cycle. In irradiations with charged particles (protons, deuterons) heat removal (cooling) of the target and the thin target window limits the particle current and thereby the production capacity. Radon emission will be a constant concern in such a process. With the (γ,n) reaction, the target window will not be limiting but such a process probably requires large to very large amounts of ²²⁶Ra and an electron accelerator facility. It is likely that methods based on high energy proton irradiation of ²³²Th require a highly complicated isotope separation based on a mass separation to remove ²²⁷Ac.

In the method according to the present invention use is made of a liquid target which contains a solution of ²²⁶radium. The use of such a liquid target is disclosed in US 2002/0094056 A1. In this known method, ²²⁶Ra is converted by gamma irradiation into ²²⁵Ra which has a half-life of 14.8 days and which converts therefore subsequently into ²²⁵Ac. The conversion of ²²⁶Ra into ²²⁵Ra is achieved by directing electrons at a converting material which produces photons. The ²²⁶Ra is either coated onto the converting material but it may also be flowed and recycled in a solution over the converting material until sufficient product is produced. The ²²⁶Ra solution may also be contained and irradiated in a quartz vial.

The advantage of a ²²⁶Ra solution as target is that sufficiently large amounts of ²²⁶Ra are available and no production and dissolution of a solid target is required. However, the separation and purification of the produced ²²⁵Ac still poses problems with the handling of the radioactive ²²⁶Ra and the radon which is continuously produced thereby. In the method disclosed in US 2002/0094056 A1 the liquid target is indeed formed by a solution of ²²⁶radium chloride. This solution may be in a concentration of from about 0.5 to about 1.5 molar, for example in a concentration of about 1 molar. After irradiation for about 10 to about 30 days, for example for about 20 days, the solution contains the ²²⁶Ra and a small amount of ²²⁵Ra and ²²⁵Ac produced in the solution. To be able to separate the produced ²²⁵Ac from the ²²⁶Ra and the ²²⁵Ra, the irradiated solution has to be dried and the dried material has to be re-dissolved in a 0.03M HNO₃ solution. This solution is passed over an ion exchange column, in particular over an LN® resin column (Eichrom Industries, Inc., Darien, III.). ²²⁶Ra and ²²⁵Ra pass through the column whilst the ²²⁵Ac is retained on the column. The bound ²²⁵Ac is subsequently eluted from the column with 0.35M HNO₃.

Although not disclosed in US 2002/0094056 A1, the ²²⁶Ra and the ²²⁵Ra can be re-used as target. Since the target is in the chloride form, re-use of these radium isotopes requires evaporation of the nitric acid solvent and re-dissolving the obtained dry material again in hydrochloric acid to obtain the radium chloride solution of the liquid target.

As explained hereabove, a problem of such a method is that it has to be performed in an enclosed environment wherein the radon gas, which is continuously produced, is captured. Due to the complex processing of the irradiated target solution to extract the produced ²²⁵Ac and to reproduce the target solution containing the remaining ²²⁶Ra, the target solution should be irradiated until it contains enough ²²⁵Ac before extracting the ²²⁵Ac from the irradiated target. In the method disclosed in US 2002/0094056 A1 the liquid target is more particularly irradiated until in particular 80-90% of the maximum production capacity is achieved. A drawback of such a long irradiation time is that after being produced the ²²⁵Ac is already decaying so that a considerably portion of the produced ²²⁵Ac is lost during the production thereof.

An object of the present invention is to provide a new method for producing ²²⁵Ac from ²²⁶Ac by irradiation of a liquid target containing the ²²⁶Ra which does not require a drying and re-dissolving step for enabling to separate the produced actinium from the radium and a further drying and re-dissolving step for producing the liquid target again starting from the separated radium. The new method should therefore enable to recycle the radium target in a more efficient and safer way after having removed the produced actinium therefrom.

To this end, the method according to the present invention is characterised in that said separation step comprises a first extraction step which is carried out in a first extraction device wherein at least part of said ²²⁵actinium is extracted from the liquid target solution while the ²²⁶radium is maintained in the liquid target solution; and in that it comprises the further step of irradiating the liquid target solution from which part of said ²²⁵actinium has been extracted again in said irradiation device to produce further ²²⁵actinium in the liquid target solution starting from the ²²⁶radium contained therein.

In the method of the present invention the liquid target solution is irradiated in the irradiation device and the same target solution is supplied, after being irradiated, to the first extraction device wherein the produced actinium is extracted from the liquid target solution itself. The irradiated target solution therefore does not need to be dried nor re-dissolved. After having extracted the actinium from the irradiated liquid target solution, the liquid target solution is irradiated as such again to produce further actinium in the target solution. Also here no drying and re-dissolving step is required for producing the liquid target. The circle is thus closed without requiring any drying and re-dissolving of the target material.

Since no drying and re-dissolving steps are required due to the fact that the liquid target solution is used as such in the successive irradiation and extraction steps, the production process can be easily automated and any escape of radon gas can be easily avoided.

The liquid target solution may be contained in a static target. Some manipulation of this static target is then required to empty it in the first extraction device and to fill it again with the liquid target solution from which the actinium has been extracted. The transfer of the liquid target solution to the first extraction device and vice versa can be automated or this single step can easily be performed in a closed environment such as in a hot cell or a glove box. The extraction of the produced actinium can for example be done once a day or every few days, for example once a week.

In a first embodiment of the method according to the present invention, said liquid target solution is circulated during said irradiation step in a first closed loop over said irradiation device and over a heat exchanger.

In this embodiment the target is thus not a static but a dynamic target. Since the target solution circulates in a closed loop the produced radon gas can be contained easily within the system/installation. An advantage of this embodiment is that the circulating liquid target solution can easily be cooled to control the temperature of the target solution in the irradiation device and thereby to cool the irradiation device, in particular the window separating the target solution from the outside.

When the radium target is irradiated with protons, the proton beam deposits its energy to the target solution and the temperature and pressure is allowed to rise during irradiation. The efficiency of heat removal is crucial, and the target and the target window have to be accurately designed to withstand the irradiation conditions. Due to the relatively long half-life of ²²⁵Ac compared to for example PET radioisotopes or other radioisotopes which are also produced by means of a cyclotron in a liquid target solution and to the limited solubility of Ra salts in aqueous solutions, the irradiation must unavoidably be long. To reach suitable production levels, as high proton current as possible should be applied yielding increased heat load on the target. Closed volume liquid targets are however limited in heat load due to the increase in internal pressure and temperature of the target liquid. Increased heat loads can to some extent be handled in liquid targets designed with internal reflux, i.e. the thermosyphone design, and could be interesting also for irradiation of Ra solutions. However, it is from a safety point of view questionable to allow increased target temperature and pressure when handling ²²⁶Ra.

In order to enable relatively high proton currents, i.e. sufficiently high production levels, the target is preferably water cooled in this first embodiment and a significant part of the heat removal is dealt with by an external cooling of the target solution itself. This embodiment allows significantly higher currents and heat loads in comparison to static liquid targets. The recirculating target liquid will provide an efficient internal cooling of the target and the target window itself, thereby increasing safety towards target window failure.

Recirculating targets have been investigated for production of ¹⁸F (Clarke 2004) but have so far not found routine application. For production of ¹⁸F, the recirculating target technology is indeed complicated primarily due to small solution volumes of the ¹⁸O enriched water used, only a few milliliters. This necessitates an extremely compact recirculation loop design so that it is not obvious to use such a recirculation loop to cool the liquid target. In the method of the present invention the problem of the extremely compact recirculation loop design is however solved by using larger but less concentrated volumes of the target solution which allow a circulation loop design with standard technology for liquid pumping and cooling. Although higher radium concentrations would be preferred in the target solution in view of the efficiency of the irradiation process, only lower radium concentrations are possible due to the limited solubility of radium salts in the aqueous solution, especially when in the aqueous solution contains already a relatively high amount of the anion in the form of an acid. The total target solution volume which is used in the production method of the present invention is in particular larger than 10 ml, more particularly larger than 20 ml, even more particularly larger than 30 ml and can be even larger than 40 ml. The total target solution volume determines also the sizes of the separation columns and is therefore preferably not too large, and is for example smaller than 250 ml, preferably smaller than 150 ml. The ²²⁶Ra concentration in the target solution is in particular lower than 1 M, and more particularly lower than 0.8 M, so that only relatively small amounts of ²²⁶Ra are required. The ²²⁶Ra can be achieved in the target solution by dissolving a ²²⁶Ra salt therein, in particular ²²⁶Ra(NO₃)₂ or ²²⁶RaCl₂. Although somewhat higher concentrations can be achieved with ²²⁶RaCl₂ compared to ²²⁶Ra(NO₃)₂, the target solution would need to contain more hydrochloric acid, reducing the solubility of the ²²⁶RaCl₂ salt, in order to be able to extract the actinium therefrom. Therefore, neither ²²⁶Ra(NO₃)₂ nor ²²⁶RaCl₂ enables to achieve higher radium concentrations in the target solution. Notwithstanding the relatively low radium concentration that can be achieved, it was found however that the method according to the present invention enables to obtain a sufficiently high productivity.

In a second embodiment of the method according to the present invention, said liquid target solution is circulated during said first extraction step in a second closed loop over said first extraction device.

Also in this second embodiment, recirculation of the target solution is again allowed in a circulation loop design with standard technology for liquid pumping. In this case for extracting the produced actinium from the target solution. An advantage of this embodiment is that, due to the fact that the liquid target solution is circulated in a closed loop over the first extraction device, the produced radon gas can again be contained easily within the system/installation. The liquid target solution may be recirculated more than once over the first extraction device. In this way, the first extraction device can be loaded maximally with actinium especially when the liquid target solution is contained in a container and is recirculated over this container and over the first extraction device.

In a third embodiment of the method according to the present invention, which is applicable to a combination of the first and the second embodiment, said liquid target solution is circulated during said irradiation step, in said first closed loop, over a container and said irradiation device and during said first extraction step, in said second closed loop, over said container and said first extraction device.

An advantage of this embodiment is that the liquid target solution does not have to be transferred from the irradiation device to the first extraction device and vice versa but can simply circulate over the irradiation device and the first extraction device. As this occurs in two closed loops, no radon gas can escape. A further advantage of this embodiment is that the irradiation step may continue during the extraction step. In other words, the irradiation step does not have to be interrupted to enable to remove the produced actinium from the target solution. The produced actinium can thus be removed more often, i.e. sooner after its production, so that less actinium is lost due to decay. Also the liquid target solution may be recirculated more than once over the first extraction device, or even semi-continuously namely mainly only interrupted for any eluting or rinsing steps. In this way, a maximum amount of the produced actinium can be withdrawn from the target solution notwithstanding the relatively large recirculated volume thereof and notwithstanding the fact that the target solution which leaves the first extraction device is mixed again with the target solution which is being fed to the first extraction device.

In a fourth embodiment of the method according to the present invention, said first extraction step is carried out during said irradiation step.

An advantage of this embodiment is that the irradiation device can be used optimally since the irradiation process does not have to be stopped to enable extraction of the produced actinium.

In a fifth embodiment of the method according to the present invention, said liquid target solution is irradiated for less than 16 days, preferably for less than 13 days, more preferably for less than 10 days and most preferably for less than 7 days before at least part of said ²²⁵actinium is extracted from the liquid target solution.

Since the actinium can be extracted easily from the liquid target solution, i.e. without any drying and re-dissolving step, it is preferably removed sufficiently early to reduce the decay of the produced actinium during the irradiation step itself.

In a sixth embodiment of the method according to the present invention, said first extraction step is carried out with pauses of less than 16 days, preferably of less than 13 days, more preferably of less than 10 days and most preferably of less than 7 days.

Again, since the actinium can be extracted easily from the liquid target solution, i.e. without any drying and re-dissolving step, it is preferably removed sufficiently early to reduce the decay of the produced actinium during the irradiation step itself.

In a seventh embodiment of the method according to the present invention, said liquid target solution is irradiated during said irradiation step with protons or deuterons.

By means of protons or deuterons ²²⁵actinium can be produced directly and effectively from ²²⁶radium. An important advantage is that commercially available cyclotrons intended for production of PET (Positron-Emission Tomography) isotopes by proton irradiation can be used. They are capable to deliver the optimal proton energy with a suitable current for the production of ²²⁵actinium. No large facilities are thus required.

In an eighth embodiment of the method according to the present invention, said liquid target solution is irradiated during said irradiation step with y irradiation to produce ²²⁵actinium by conversion of ²²⁶radium into ²²⁵radium and by conversion of ²²⁵radium into ²²⁵actinium.

An advantage of this embodiment is that, compared to proton irradiation, the target technology and irradiation may be technically easier as heat removal is less of an issue and the target window does not have to be thin.

Preferably, during said first extraction step the ²²⁵radium is maintained in the liquid target solution when the ²²⁵actinium is extracted therefrom.

An advantage of this preference is that the ²²⁵radium is recycled so that ²²⁵actinium is produced immediately again, without any time-lag, in the liquid target solution.

In a ninth embodiment of the method according to the present invention, said liquid target solution comprises a solution of a ²²⁶radium salt and its corresponding acid, the solution preferably comprising ²²⁶radium nitrate and nitric acid.

As explained hereabove, although radium chloride has a higher solubility in water than radium nitrate, it normally will require a larger amount of the corresponding acid in the solution, i.e. of HCl, which reduces the solubility of radium chloride. The required concentration of HCl may comprise for example about 5 M.

An advantage of the use of radium nitrate in combination with nitric acid is that there exist different extraction chromatographic resins which enable to extract ²²⁵actinium and not ²²⁶Ra (or even not ²²⁵Ra when produced), including extraction chromatographic resins (e.g. LN resins containing dialkyl phosphoric acid) which enable to extract ²²⁵actinium from a solution having a relatively small nitric acid content (having only a relatively small effect on the solubility of radium nitrate), and which can be eluted with a nitric acid solution having a larger nitric acid content, and extraction chromatographic resins (e.g. DGA (diglycolamide) based resins for example N,N,N′,N′-tetra-n-octyldiglycolamide or N,N,N′,N′-tetrakis-2-ethylhexyldiglycolamide, TRU resin based on CMPO, i.e. octylphenyl-N,N-di-isobutyl carbamoyle phosphine oxide or resins based on a diamides, e.g. DMDOHEMA or DMDBTDMA) which enable to extract ²²⁵actinium from a solution having a relatively large nitric acid content, and which can be eluted with a nitric acid solution having a smaller nitric acid content. The use of a succession of these different extraction chromatographic resins thus enable to extract the ²²⁵actinium from the liquid target solution, to elute the ²²⁵actinium from the first extraction chromatographic resin and to extract the ²²⁵actinium again from the eluate, in a purer an more concentrated form, by means of the second extraction chromatographic resin. Depending on the nitric acid content of the liquid target solution, the succession of the two extraction chromatographic resins can be reversed.

A further advantage of the use of radium nitrate in combination with nitric acid is that corrosion by chlorides is a much bigger problem compared to corrosion issues in nitrate media. There are many materials which are essentially corrosion resistant even at higher concentrations of nitric acid. There are few materials that are suitable for hydrochloric acid. This situation is further complicated by the irradiation conditions in which reactive radicals are produced. These problems can be solved by the use of nitric acid.

In a tenth embodiment of the method according to the present invention, said first extraction device comprises a first adsorbent onto which said ²²⁵actinium accumulates during said first extraction step, the method comprising a first elution step wherein at least part of the ²²⁵actinium which has been accumulated onto said first adsorbent is eluted therefrom by means of a first eluent.

In this embodiment, the ²²⁵actinium can easily be extracted from the liquid target solution since it accumulates onto said first adsorbent during the first extraction step. The first extraction device is preferably an extraction chromatographic device wherein said first adsorbent preferably comprises a support, preferably an inert support, and an extractant as stationary phase on said support.

In an eleventh embodiment of the method according to the present invention, which is applicable to the tenth embodiment, said liquid target solution has a predetermined pH value such that said ²²⁵actinium accumulates during said first extraction step onto said first adsorbent whilst said first eluent has a pH value which is different from the pH value of the liquid target solution such that said ²²⁵actinium is eluted during said first elution step from said first adsorbent.

An advantage of this embodiment is that both the liquid target solution and the first eluent may contain a same acid, but only in a different concentration, so that any acid of the target solution remaining in the first adsorbent cannot disturb the first elution step and, vice versa, so that any acid of the first eluent remaining in the first adsorbent cannot disturb the first extraction step.

In a twelfth embodiment of the method according to the present invention, which is applicable to the eleventh embodiment, the method comprises a rinsing step in between said first extraction step and said first elution step wherein said first extraction device is rinsed with a rinse solution which has a pH value different from the pH value of said first eluent such that said ²²⁵actinium remains onto said first adsorbent, the rinse solution preferably having a pH value which is substantially equal to the pH value of said liquid target solution.

An advantage of this embodiment is that any radium remaining in the first adsorbent at the end of the first extraction step can be washed out before the actinium is eluted from the first adsorbent so that the radium is not lost, but remains in the system/installation, and cannot form impurities in the extracted actinium. By radium is meant in the present specification any radium isotope, in particular ²²⁶radium and optionally also ²²⁵radium in case this is produced during the irradiation step.

Preferably, the rinse solution urges the liquid target solution during said rinsing step out of the first extraction device, preferably without being mixed with the liquid target solution, and the first eluent urges the rinse solution during said first elution step out of the first extraction device, preferably without being mixed with the rinse solution.

In a thirteenth embodiment of the method according to the present invention, which is applicable to the twelfth embodiment, said rinse solution is circulated during said rinsing step in a third closed loop over a radium extraction device which comprises a radium adsorbent onto which the radium rinsed from said first adsorbent by means of said rinse solution accumulates during said rinsing step, the method comprising a radium elution step wherein at least part of the radium which has been accumulated onto said radium adsorbent is eluted therefrom by means of a radium eluent, the radium eluent having in particular a pH value which is different from the pH value of said rinse solution such that said radium is eluted during said radium elution step from said radium adsorbent.

An advantage of this embodiment is that any radium rinsed from the first extraction device can be recovered. It can be stored for some time in the radium eluent and it can be recovered by reconditioning the radium solution to the correct acidity, by concentrating it and by transferring it back to the target solution. Since only a small amount of radium will be rinsed out of the first extraction device, this recovering operation only has to be performed from time to time.

In a fourteenth embodiment of the method according to the present invention, which is applicable to the thirteenth embodiment, the ²²⁶radium which is eluted during said ²²⁶radium elution step from said ²²⁶radium adsorbent is therefore preferably stored and is subsequently recycled to said liquid target solution.

In a fifteenth embodiment of the method according to the present invention, which is applicable to any one of the twelfth to the fourteenth embodiment, said rinse solution is circulated over a first radon filter, in particular a first activated carbon filter, to remove radon from said first extraction device.

The radon produced in the first extraction device, and the radon produced in the irradiation device and which is collected in the first extraction device, can be removed therefrom by the first radon filter when rinsing the first extraction device over this filter. This filter is for example an activated carbon filter onto which the radon adheres. This radon subsequently decays to produce ²¹⁰Pb which remains in the system/installation. To enable to remove the ²¹⁰Pb from the system/installation, a lead extraction device can be provided therein, for example an extraction chromatography column containing for example an Sr resin or Pb resin (Eichrome), both highly efficient towards removing Pb.

In a sixteenth embodiment of the method according to the present invention, which is applicable to any one of the twelfth to the fifteenth embodiment, said rinse solution comprises an acid solution which contains the same acid as said target solution, in particular nitric acid.

In a seventeenth embodiment of the method according to the present invention, which is applicable to any one of the tenth to the sixteenth embodiment, said first eluent comprises a first acid solution which contains the same acid as said target solution, in particular nitric acid.

The liquid target solution, the rinse solution and the first eluent solution preferably comprise the same acid but are not allowed to mix as this would lead to disturbance in the production process, especially when it is carried out for a relatively long time. The volume of the rinse solution contained in the first extraction device is therefore preferably pushed back into its recirculation loop by the first eluent before the first eluent is recirculated over the second extraction device.

In a eighteenth embodiment of the method according to the present invention, which is applicable to any one of the tenth to the seventeenth embodiment, said first eluent is circulated during said first elution step in a fourth closed loop over a second extraction device which comprises a second adsorbent onto which the ²²⁵actinium eluted from said first adsorbent by means of said first eluent accumulates during said first elution step, the method comprising a second elution step wherein at least part of the ²²⁵actinium which has been accumulated onto said second adsorbent is eluted therefrom by means of a second eluent, the second eluent having in particular a pH value which is different from the pH value of said first eluent such that said ²²⁵actinium is eluted during said second elution step from said second adsorbent, the second eluent comprising preferably a second acid solution which contains the same acid as said target solution, in particular nitric acid.

The actinium eluted from the first extraction device can thus easily be collected in the second extraction device, and can again be eluted therefrom in a more concentrated and pure form. Preferably, the second eluent urges the first eluent during said second elution step out of the second extraction device, preferably without being mixed with the first eluent.

In a nineteenth embodiment of the method according to the present invention, which is applicable to the eighteenth embodiment, said first eluent is circulated from said first extraction device to said second extraction device over a second radon filter, in particular a second activated carbon filter, to extract radon from said first eluent.

The radon produced in the first extraction device, and the radon produced in the irradiation device and which is collected in the first extraction device, can be removed therefrom by the second radon filter when the first extraction device is eluted. This filter is again for example an activated carbon filter onto which the radon adheres. This radon subsequently decays to produce ²¹⁰Pb which remains in the system/installation. To enable to remove the ²¹⁰Pb from the system/installation, a lead extraction device can be provided therein, for example an extraction chromatography column containing for example an Sr resin or a Pb resin (Eichrome) both highly efficient towards removing

Pb.

In a twentieth embodiment of the method according to the present invention, which is applicable to the eighteenth or nineteenth embodiment, said second eluent is circulated during said second elution step in a fifth closed loop over a third extraction device which comprises a third adsorbent onto which the ²²⁵actinium eluted from said second adsorbent by means of said second eluent accumulates during said second elution step, the method comprising a third elution step wherein at least part of the ²²⁵actinium which has been accumulated onto said third adsorbent is eluted therefrom by means of a third eluent, the third eluent having in particular a pH value which is different from the pH value of said second eluent such that said ²²⁵actinium is eluted during said third elution step from said third adsorbent, the third eluent comprising preferably a third nitric acid solution.

The actinium eluted from the second extraction device can thus easily be collected in the third extraction device, and can again be eluted therefrom in a more concentrated and/or pure form. Preferably, the third eluent urges the second eluent during said third elution step out of the third extraction device, preferably without being mixed with the second.

In a twenty-first embodiment of the method according to the present invention, which is applicable to the twentieth embodiment, said second eluent is circulated from said second extraction device to said third extraction device over a third radon filter, in particular a third activated carbon filter, to extract radon from said second eluent.

Any radon which arrives in the second extraction device, can be removed therefrom by the second radon filter when the second extraction device is eluted. This filter is again for example an activated carbon filter onto which the radon adheres. This radon subsequently decays to produce ²¹⁰Pb which remains in the system/installation. To enable to remove the ²¹⁰Pb from the system/installation, a lead extraction device can be provided therein, for example an extraction chromatography column containing for example an Sr resin or Pb resin (Eichrome) both highly efficient towards removing Pb.

Further details and advantages of the present invention will become apparent from the following description of some examples to the production method according to the invention. This description is only given by way of example and is not intended to limit the scope of the invention as defined in the appended claims. The reference numerals used in this description refer to the accompanying drawings wherein:

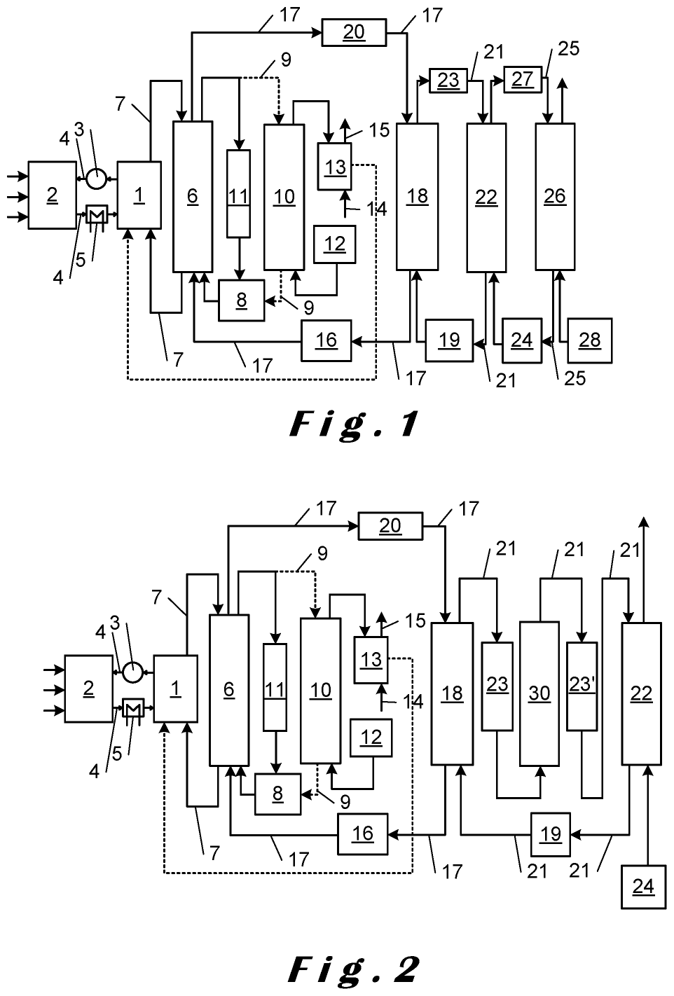

FIG. 1 is a diagram of an installation for carrying out a method according to a first embodiment of the present invention, wherein the liquid target solution contains a relatively small amount of nitric acid, in particular 0.02 M; and

FIG. 2 is a diagram of an installation for carrying out a method according to a second embodiment of the present invention, wherein the liquid target solution contains a larger amount of nitric acid, in particular 0.5 M.

In the method of the present invention a liquid target solution is made which contains ²²⁶Ra, more particularly ²²⁶radium nitrate. This solution comprises in particular between 0.005 and 1.0 M nitric acid. It is preferably contained in a gas tight bottle which is lead shielded.

The installation as schematically illustrated in FIG. 1 is in particular intended to produce ²²⁵Ac in a accordance with a low acidity option, i.e. wherein the liquid target solution has for example an acidity comprised between 0.005 and 0.05 M HNO₃. The concentration of Ra(NO₃)₂ in the target solution is preferably as high as possible, and can be as high as 0.4 M.

The installation comprises a container 1 arranged to contain the liquid target solution. It also contains an irradiation device 2 having a window through which the target solution can be irradiated with protons, deuterons or gamma radiation. The gamma irradiation can be obtained from a synchrotron or a linac, or it can also be obtained by means of a converting material as disclosed in US 2002/0094056. The liquid target is however preferably irradiated with protons (or deuterons) since this is the most efficient way to produce ²²⁵Ac from ²²⁶Ra. The proton irradiation may be generated by a cyclotron, for example a cyclotron which is already generally known for producing PET radioisotopes such as ¹⁸F from ¹⁸O.

The liquid target may be a static target but in order to enable a more efficient cooling, and thus in order to enable a more energetic irradiation of the target to increase the production capacity, the liquid target is preferably a recirculating liquid target as in the embodiment illustrated in FIG. 1. In this embodiment the target solution is pumped by means of a pump 3, in a first closed loop 4, from the container 1 over the irradiation device 2 and subsequently over a heat exchanger 5 back into the container 1. The target is preferably also cooled, in particular water cooled, in the irradiation device 2 itself. The solution is preferably irradiated with protons having preferably an incident energy of 15-20 MeV. During the irradiation the heat generated by stopping the protons in the target solution is totally or partly removed by the target solution itself and is externally exchanged in the primary heat exchanger 5. The complete irradiation loop is set-up so that all wetted parts are of highly inert, gas tight materials, typically hastalloy, inconel, etc. to avoid corrosion and ensure leak tightness. Ceramics or a combination of metal and ceramics could be a good choice as well.

During irradiation ²²⁵Ac is constantly building up in the target solution. Using a static target, when the irradiation is finished, the target solution is collected back into the gas tight target solution bottle. The static target is preferably automatically loaded an emptied. A recirculating liquid target can be reprocessed during the irradiation process. From there, chemical separation and purification of ²²⁵Ac is carried out by recirculating flows over extraction chromatography or ion exchange columns. The conditions are set so that actinium is extracted on the columns, whereas impurities are recirculated. The size of the columns, flow-rates, volumes of solutions are dependent on the initial volume of the target solution.

For a static target, the irradiated target solution contained in the bottle can be transferred and recirculated over a first extraction device 6. In this extraction device 6 the ²²⁵Ac is extracted from the irradiated target solution while the ²²⁶Ra (and optionally also the ²²⁵Ra in case of gamma irradiation of the target solution) is maintained in the target solution. The target solution from which the ²²⁶Ac has been extracted is collected again in the bottle and is loaded back into the liquid target to be irradiated again.

In the installation shown in FIG. 1, extracting the ²²⁵Ac from the liquid target solution and loading the liquid target solution from which the ²²⁵Ac has been extracted back into the liquid target requires much less handling steps and is much easier to perform, in particular in an automatic way. In the embodiment illustrated in FIG. 1 the irradiated target solution contained in the container 1 is indeed recirculated, in a second closed loop 7 over the first extraction device 6. This is done by means of a pump which has not been indicated in FIG. 1.

The first extraction device comprises a first adsorbent onto which the ²²⁵Ac accumulates during the first extraction step. The first extraction device preferably comprises a first extraction chromatography column which, in the low acidity option, is for example based on the LN-resin (Eichrome, HDEHEP). When the target solution comprises for example between 0.005 and 0.05 M HNO₃, such as for example 0.02 M HNO₃, actinium is retained on the column and ²²⁶Ra (and ²²⁵Ra, if present) is recirculated. The recirculated volume will determine the efficiency of the uptake of Ac from the target solution and it is important to limit this volume so that Ac breakthrough is avoided.

Losses of Ra from the target solution are preferably prevented. It is important that the majority of the target solution volume present in the initial column after separation of ²²⁵Ac from ²²⁶Ra is pushed back into the target solution container 1.

Any radium still in the first extraction device 6 after the initial separation, i.e. after the liquid target solution has pumped or percolated through the column, is recuperated by rinsing the column of the first extraction device 6 with a rinse solution 8. This rinse solution has a pH similar to the pH of the liquid target solution so that the ²²⁵Ac is retained on the column during the rinsing step. The rinse solution is circulated in a third closed loop 9 over the first extraction device 6 and a radium extraction device 10, for example over a strong cation exchange column (for example DOWEX 50W or Biorad 50W or similar). The radium extraction device 10 comprises a radium adsorbent onto which the radium rinsed from the first adsorbent by means of the rinse solution 8 accumulates during the rinsing step.

To remove any radon that has been accumulated in the first extraction device 6 the rinse solution 8 is preferably also recirculated over a first activated carbon filter 11 to remove radon gas from the first extraction device 6. The activated carbon filter 11 may be a granulated activated carbon filter but is preferably a powdered activated carbon filter.

Further purification and concentration, as the columns decrease in size and thereby also the elution volume, is carried out by extraction chromatography columns based on Ln resin, Sr resin, DGA resin or branched-DGA resin (all Eichrome). Acidity changes move actinium from one extraction column to the next one each time improving purity and increasing the concentration factor. The last column in the process will determine in which medium the actinium product is leaving the process. In FIG. 1 a SCE (strong cation exchanger) is used and a corresponding high acidity will be used to elute actinium. An alternative would be an extraction chromatography resin selective for trivalent elements such as DGA or DGA-B (Eichrom) in which elution of actinium is carried out at lower acidity.

In the embodiment illustrated in FIG. 1, the radium that has been accumulated in the radium extraction device 10 is more particularly eluted therefrom by means of a radium eluent 12 which has a pH value or acidity which is different from the pH value or acidity of the rinse solution such that the radium is eluted during the radium elution step from the radium adsorbent. The rinse solution 8 may for example comprise a 0.02 M nitric acid solution whilst the radium eluent 12 may comprise for example a 2 M nitric acid solution. The radium eluent 12 containing the recovered radium is stored in a gastight container 13. This container 13 is provided with a gas inlet 14 and a gas outlet 15. The container 13 can thus be purged with a small volume of, for example, nitrogen gas to remove any radon gas that is produced in the container 13 during the storage of the radium contained therein. Since only a small volume is used, Rn can be trapped and managed by a small active carbon gas filter (not shown in FIG. 1 and FIG. 2). The recovered Ra can, if needed, be reconditioned to the correct acidity, concentrated and transferred back to the target solution.

The ²²⁵Ac which has been accumulated onto the first adsorbent in the first extraction device 6 is eluted therefrom, in a first elution step after the rinsing steps, by means of a first eluent 16. This first eluent 16 has a pH value which is different from the pH value of the liquid target solution such that the ²²⁵Ac is eluted during the first elution step from the first adsorbent contained in the first extraction device 6. The first eluent 16 may comprise a first nitric acid solution which has a lower pH, i.e. a higher acidity, and which contains for example 0.5 M HNO₃. With such an eluent, ²²⁵Ac can be removed from the Ln resin.

The first eluent 16 is circulated during the first elution step, in a fourth closed loop 17 over the first extraction device 6 and over a second extraction device 18 which comprises a second adsorbent onto which the ²²⁵actinium eluted out of the first extraction device 6 by means of the first eluent 16 accumulates during the first elution step. The second extraction device preferably comprises a second extraction chromatography column which, in the low acidity option illustrated in FIG. 1, is for example based on the DGA-resin (Eichrome, TODGA). When the first eluent 16 comprises for example 0.5 M HNO₃, actinium is retained on the DGA-column and impurities are recirculated. The free column volume of the second extraction device 18 is preferably smaller than the free column volume of the first extraction device 6 so that the actinium can be concentrated thereon, and can be eluted therefrom with a smaller amount of a second eluent 19.

In order to remove any radon gas which may be present in the fourth closed loop 17 of the installation, the first eluent 16 is circulated from the first extraction device 6 to the second extraction device 18 over a second radon filter 20, in particular a second activated carbon filter, to extract radon from the first eluent 16. The second activated carbon filter 20 may be a granulated activated carbon filter but is preferably a powdered activated carbon filter.

When the ²²⁵actinium has been accumulated onto the second adsorbent contained in the second extraction device 18 it is eluted therefrom, in a second elution step, by means of the second eluent 19. The second eluent has a pH value or acidity which is different from the pH value or acidity of the first eluent 8 such that the ²²⁵actinium is eluted during the second elution step from the second adsorbent contained in the second extraction column. The second eluent 19 comprising again preferably a second nitric acid solution and comprises, in the low acidity option illustrated in FIG. 1, for example 0.05 M HNO₃. With such a second eluent, ²²⁵Ac can be removed from the DGA resin.

The second eluent 19 is circulated during the second elution step, in a fifth closed loop 21 over the second extraction device 18 and over a third extraction device 22 which comprises a third adsorbent onto which the ²²⁵actinium eluted out of the second extraction device 18 by means of the second eluent 19 accumulates during the second elution step. The third extraction device 22 preferably comprises a third extraction chromatography column which, in the low acidity option illustrated in FIG. 1, is for example based again on the Ln-resin (Eichrome, HDEHEP). When the second eluent 19 comprises for example 0.05 M HNO₃, actinium is retained on the Ln-column and impurities are recirculated. The free column volume of the third extraction device 22 may be equal to the free column volume of the second extraction device 18 if no further concentration is necessary.

In order to remove any radon gas which may be present in the fifth closed loop 21 of the installation, the second eluent 19 is circulated from the second extraction device 18 to the third extraction device 22 over a third radon filter 23, in particular a third activated carbon filter, to extract radon from the second eluent 19. The third activated carbon filter 23 may be a granulated activated carbon filter but is preferably a powdered activated carbon filter.

When the ²²⁵actinium has been accumulated onto the third adsorbent contained in the third extraction device 22 it is eluted therefrom, in a third elution step, by means of a third eluent 24. The third eluent 24 has a pH value or acidity which is different from the pH value or acidity of the second eluent 19 such that the ²²⁵actinium is eluted during the third elution step from the third adsorbent contained in the third extraction column ²². The third eluent 24 comprising again preferably a third nitric acid solution and comprises, in the low acidity option illustrated in FIG. 1, for example 0.5 M HNO₃. With such a third eluent, ²²⁵Ac can be removed from the Ln resin.

A further purification, and optional concentration, of the ²²⁵Ac is obtained in the embodiment of FIG. 1 by circulating the third eluent 24 during the third elution step, in a sixth closed loop 25 over the third extraction device 22 and over a fourth extraction device 26 which comprises a fourth adsorbent onto which the ²²⁵actinium eluted out of the third extraction device 22 by means of the third eluent 24 accumulates during the third elution step. The fourth extraction device 26 may comprise again a DGA or a DGA-B (branched) column in which the acidity may be lowered to 0.1 M to remove the ²²⁵Ac therefrom in the last step. The fourth extraction device 26 preferably comprises however an SCE (strong cation exchanger). When the third eluent 24 comprises for example 0.5 M HNO₃, actinium is retained on the SCE 26 and impurities are recirculated. The free column volume of the fourth extraction device 26 may be equal to or smaller than the free column volume of the second extraction device 18, and may be equal to about half the free column volume thereof to be able to further concentrate the ²²⁵Ac.

In order to remove any radon gas which may be present in the sixth closed loop 25 of the installation, the third eluent 24 is circulated from the third extraction device 22 to the fourth extraction device 26 over a fourth radon filter 27, in particular a fourth activated carbon filter, to extract radon from the third eluent 24. The fourth activated carbon filter 27 may be a granulated activated carbon filter but is preferably a powdered activated carbon filter.

When the ²²⁵actinium has been accumulated onto the fourth adsorbent contained in the fourth extraction device 26 it is eluted therefrom, in a fourth elution step, by means of a fourth eluent 28.

In case the fourth extraction device 26 comprises a DGA or DGA-B resin, the fourth eluent 28 has a pH value or acidity which is different from the pH value or acidity of the third eluent 24 such that the ²²⁵actinium is eluted during the fourth elution step from the fourth adsorbent contained in the fourth extraction column 26. The fourth eluent 28 comprising again preferably a fourth nitric acid solution and comprises, in the low acidity option illustrated in FIG. 1, for example 0.1 M HNO₃. With such a fourth eluent, ²²⁵Ac can be removed from the DGA or DGA-B resin.

In case the fourth extraction device 26 is an SCE, the fourth eluent 28 has a sufficiently high pH or acidity to elute the ²²⁵Ac from the SCE. The fourth eluent 28 comprising again preferably a fourth nitric acid solution which has in this case a high acidity, and which comprises for example 2 M HNO₃.

The obtained purified and concentrated ²²⁵Ac can be removed through the outlet 29 of the fourth extraction device and can subsequently be dried to obtain a dry product. During the drying step not only the water but also the acid contained in the fourth eluent can be removed by evaporation.

As an example, the different extraction devices and solutions used in the installation as illustrated in FIG. 1 may have the following compositions:

TABLE 1
Example of compositions of extraction devices and solutions which
may be used in the installation as illustrated in FIG. 1.

| | |
|---|---|
| Target solution | 0.02M HNO₃ and 0.4M ²²⁶Ra(NO₃)₂ |
| First extraction device 6 | Ln resin (Eichrome, HDEHEP) |
| Rinse solution 8 | 0.02M HNO₃ |
| Radium extraction device 10 | SCE (DOWEX 50W) |
| Radium eluent 12 | 2M HNO₃ |
| First eluent 16 | 0.5M HNO₃ |
| Second extraction device 18 | DGA (Eichrome, TODGA) |
| Second eluent 19 | 0.05M HNO₃ |
| Third extraction device 22 | Ln resin (Eichrome, HDEHEP) |
| Third eluent 24 | 0.5M HNO₃ |
| Fourth extraction device 26 | SCE (DOWEX 50W) |
| Fourth eluent 28 | 2M HNO₃ |

FIG. 2 illustrates an alternative embodiment of the method according to the present invention wherein the liquid target solution has a higher acidity (lower pH). This high acidity option is based on an initial Ac/Ra separation using a DGA column. Here the acidity in the target solution will be for example between 0.1 M and 0.5 M nitric acidity and the concentration of ²²⁶Ra in the target solution can be up to 0.35 M, if the lower acidity is compensated with addition of nitrates, e.g. through ammoniumnitrate. The actinium will be removed by recirculation over the DGA column. The recirculated volume should be high enough to efficiently remove the Ac but within the capacity of the column to avoid Ac breakthrough. As in the low acidity option, a strong cation exchanger will manage any Ra left on the column after the initial actinium separation. Further purification takes place by lowering the acidity and the uptake on a Ln resin column. Here the acidity is chosen to avoid co-extraction of Pb, i.e. 0.03 M-0.075 M. Different options are available from this point but the subsequent purification and concentration using a DGA or DGA B column will probably be the preferred method.

The parts of the installation illustrated in FIG. 2 which correspond to the installation illustrated in FIG. 1 are indicated with the same reference numerals. The installation illustrated in FIG. 2 functions in a same way as the installation described hereabove with reference to FIG. 1 so that the description of the functioning of the common parts is not repeated. Instead, a specific example, the different extraction devices and solutions used in the high acidity installation as illustrated in FIG. 2 is given in the following table:

TABLE 2
Example of compositions of extraction devices and solutions which may
be used in the high acidity installation as illustrated in FIG. 2.

| | |
|---|---|
| Target solution | 0.5M HNO₃ and 0.35M ²²⁶Ra(NO₃)₂ |
| First extraction device 6 | DGA (Eichrome, TODGA) |
| Rinse solution 8 | 0.5M HNO₃ |
| Radium extraction device 10 | SCE (DOWEX 50W) |
| Radium eluent 12 | 2M HNO₃ |
| First eluent 16 | 0.05M HNO₃ |
| Second extraction device 18 | Ln resin (Eichrome, HDEHEP) |
| Second eluent 19 | 0.5M HNO₃ |
| Third extraction device 22 | DGA (Eichrome, TODGA) |
| Third eluent 24 | 0.1M HNO₃ |
| Lead extraction device 30 | Sr resin (Eichrome,) |

As can be seen, the concentrated and purified ²²⁵Ac is removed already from the third extraction device 22. An additional extraction column, namely a lead extraction device 30, is however provided in the fifth closed loop 21 in between the second 18 and the third extraction device ²². The lead extraction device 30 is preceded by the third radon filter 23 and is followed by an additional radon filter 23′.

The lead extraction device 30 comprises in particular a Sr resin which is highly effective towards Pb and can be used to remove Pb from the installation/system. Pb is produced by decay of radon. Radon decays by alpha decay and generates radiation damage to the column materials which will affect column separation performance. Radon is therefore preferably be prevented from moving downstream in the process so that the life-time of the columns is extended and to avoid radon contamination of the ²²⁵Ac product. Radon is managed by the radon filter, i.e. by the small columns containing powdered activated carbon (PAC) or granulated activated carbon (GAC). The radon is absorbed/strongly delayed in the PAC/GAC column and decays into ²¹⁰Pb, a gamma emitter. ²¹⁰Pb will be eluted into the aqueous phase and contained within the process. The PAC/GAC columns can be used multiple times. The Sr resin column is highly efficient towards Pb and can thus be used to remove Pb from the process. The Sr resin column comprises as stationary phase dicyclohexano-18-crown-6 derivative which is dissolved in octanol.

Also in the low acidity installation of FIG. 1, a lead extraction device (Sr resin column) can easily be incorporated, in particular in between the third extraction device 22 and the fourth extraction device 26, with preferably the fourth radon filter 27 before and an additional radon filter after the lead extraction device.

The method according to the present invention enables to achieve commercially interesting production rates notwithstanding the relatively low concentration of ²²⁶Ra in the target solution as a result of the limited solubility of radium nitrate (which is for example more than ten times smaller than the solubility of ⁶⁸zinc nitrate which is used in liquid targets to produce ⁶⁸Ga by the ⁶⁸Zn(p,n)⁶⁸Ga reaction).

The ²²⁵Ac production rate can be calculated. The energy dependent cross-section (IAEA ENDF database) for the ²²⁶Ra(p,2n) reaction together with the energy dependent stopping power for protons in an aqueous solution (Nucleonica) containing up to 0.4 M ²²⁶Ra(NO₃)₂ is used to obtain production rates in small layers of the liquid target which are summed to yield the overall formation of ²²⁵Ac. Weekly production rates are shown in Table 1 as a function of the used proton current.

TABLE 3
²²⁵Ac production as a function of proton current.
0.35M ²²⁶Ra, Irradiation time = 7 days,
Cooling time = 0 days, Cross-section = 500 mb.

| Current (μA) | A (Bq) | A (mCi) | Heat (W) |
|---|---|---|---|
| 10 | 1.27E+09 | 34.4 | 225 |
| 20 | 2.54E+09 | 68.8 | 450 |
| 30 | 3.82E+09 | 103.2 | 675 |
| 40 | 5.09E+9 | 137.6 | 900 |
| 50 | 6.36E+9 | 171.9 | 1125 |
| 60 | 7.63E+9 | 206.3 | 1350 |
| 70 | 8.91E+9 | 240.7 | 1575 |
| 80 | 1.02E+10 | 275.1 | 1800 |
| 90 | 1.15E+10 | 309.5 | 2025 |
| 100 | 1.27E+10 | 343.9 | 2250 |

As to the economic feasibility, assuming that therapeutic treatments using ²²⁵Ac are approved, the demand for ²²⁵Ac will significantly increase. The ²²⁵Ac produced by the proposed method will be of higher quality than ²²⁵Ac produced by proton irradiation of ²³²Th targets, unless a complicated isotopic separation of ²²⁷Ac is undertaken. If distributed as produced, assuming 40 weeks production per year, the produced ²²⁵Ac could cover an excess of 25000 treatments. The economic feasibility in an actinium production process can thus most likely be guaranteed.

### REFERENCES

Boll, R. A., Malkemus, D., Mirzadeh, S., Production of actinium-225 for alpha particle mediated radioimmunotherapy. Appl. Radiat. Isot. 62, 667-679 (2005)
Jost, C. U., Griswold, J. R., Bruffey, S. H., Mirzadeh, S., Stracener, D. W., Williams, C. L., Measurement of cross sections for the ²³²Th(p,4n)²²⁹Pa reaction at low proton energies. AIP Conference Proceedings: International Conference on Application of Accelerators in Research and Industry. Vol. 1525, pp. 520-524. (2013)
Koch, L, Fuger, J, van Geel J., Process for producing Actinium-225, EP0752709, 1999
Apostolidis, C., Molinet, R., McGinley, J., Abbas, K., Möllenbeck, J., Morgenstern, A., Cyclotron production of Ac-225 for targeted alpha therapy, Appl. Radiat. Isot., 62, 383-387 (2005)
Abbas, K., Apostolidis, C., Janssens, W., Stamm, H., Nikula, T., Carlos, R., Method for produing Actinium 225, EP1455364, 2004
Apostolidis, C., Janssens, W., Koch, L., Mcginley, J., Molinet, R., Ougier, M., Van Geel, J., Möllenbeck, J., Schweickert, H., Method for producing Ac-225 by irradiation of Ra-226 with protons, EP062942, 2004
Morgenstern, A., Apostolidis, C., Molinet, R., Lutzenkirchen, K., Method for producing actinium-225, US patent 20060072698, (2006)

### Ermolaev, S. V., Zhuikov, B. L. Kokhanyuk, V. M., Matushko, V. L., Kalmykov Stepan, N., Aliev Ramiz, A. Tananaev Ivan, G.

Myasoedov, B. Production of actinium, thorium and radium isotopes from natural thorium irradiated with protons up to 141 MeV Radiochim. Acta, 100, p. 223 (2012)
Weidner, J. W., Mashnik, S. G., John, K. D., Hemez, F., Ballard, B., Bach, H., Birnbaum, E. R., Bitteker, L. J. Couture, A., Dry, D., et al. Proton-induced cross sections relevant to production of ²²⁵Ac and ²²³Ra in natural thorium targets below 200 MeV, Appl. Radiat. Isot., 70, pp. 2602-2607, (2012)
Griswold, J. R., Medvedev, D. G., Engle, J. W., Copping, R. Fitzsimmons, J. M., Radchenko, V., Cooley, J. C., Fassbender, M. E., Denton, D. L., Murphy, K. E., Owens, A. C., Birnbaum, E. R., John, K. D., Nortier, F. M., Stracener, D. W., Heilbronn, L. H., Mausner, L. F. Mirzadeh, S., Large Scale Accelerator Production of ²²⁵Ac: Effective Cross Sections for 78-192 MeV Protons Incident on 232Th targets, Applied Radiation and Isotopes, 118, 366-374, (2016)
Zhuikov, B. L., Kalmykov, S. N., S. V. Ermolaev, S. V., Aliev, R. A., Kokhanyuk, V. M., Matushko, V. L., Tananaev, I. G., Myasoedov B. F., Production of ²²⁵Ac and ²²³Ra by irradiation of Th with accelerated protons, Radiochemistry, 53, pp. 73-80, (2011)
Koch, L, Fuger, J, van Geel J., Process for producing Actinium-225 from radium-226, EP0752710, 1999-1
Melville, G. Meriarty, H., Metcalfe, P., Knittel, T., Allen, B. J. Production of Ac-225 for cancer therapy by photon-induced transmutation of Ra-226, Applied Radiation and Isotopes, 65, 1014-1022, (2007)
Melville G., Allen, B. J., Cyclotron and linac production of Ac-225, Applied Radiation and Isotopes, 67, 549-555, (2009)

### Clarke, J. C., High-Powered Cyclotron Recirculating Target for Production of the ¹⁸F Radionuclide, PhD Thesis, North Carolina State University (2004)

1. A method for producing ²²⁵actinium from ²²⁶radium, said method comprising the steps of:
providing a liquid target solution containing ²²⁶radium;
irradiating said liquid target solution in an irradiation device (2) to produce ²²⁵actinium in the liquid target solution starting from the ²²⁶radium contained therein; and
separating at least part of the produced ²²⁵actinium from the remaining ²²⁶radium, wherein
said separation step comprises a first extraction step which is carried out in a first extraction device (6) wherein at least part of said ²²⁵actinium is extracted from the liquid target solution while the ²²⁶radium is maintained in the liquid target solution; and in that the method comprises the further step of:
irradiating the liquid target solution from which part of said ²²⁵actinium has been extracted again in said irradiation device (2) to produce further ²²⁵actinium in the liquid target solution starting from the ²²⁶radium contained therein.

2. The method according to claim 1, wherein said liquid target solution is circulated during said irradiation step in a first closed loop (4) over said irradiation device (2) and over a heat exchanger (5).

3. The method according to claim 1, wherein said liquid target solution is circulated during said first extraction step in a second closed loop (7) over said first extraction device (6).

4. The method according to claim 2, wherein said liquid target solution is circulated during said irradiation step, in said first closed loop (4), over a container (1) and said irradiation device (2) and during said first extraction step, in said second closed loop (7), over said container (1) and said first extraction device (6).

5. The method according to claim 1, wherein said liquid target solution is irradiated for less than 16 days, before at least part of said ²²⁵actinium is extracted from the liquid target solution.

6. The method according to claim 1, wherein said liquid target solution is irradiated during said irradiation step with protons or deuterons.

7. The method according to claim 1, wherein said liquid target solution is irradiated during said irradiation step with γ irradiation to produce ²²⁵actinium by conversion of ²²⁶radium into ²²⁵radium and by conversion of ²²⁵radium into ²²⁵actinium.

8. The method according to claim 7, characterised in that wherein during said first extraction step the ²²⁵radium is maintained in the liquid target solution.

9. The method according to claim 1, wherein said liquid target solution comprises a solution of a ²²⁶radium salt and its corresponding acid, the solution preferably comprising ²²⁶radium nitrate and nitric acid.

10. The method according to claim 1, wherein said first extraction device (6) comprises a first adsorbent onto which said ²²⁵actinium accumulates during said first extraction step, the method comprising a first elution step wherein at least part of the ²²⁵actinium which has been accumulated onto said first adsorbent is eluted therefrom by means of a first eluent (16).

11. The method according to claim 10, wherein said liquid target solution has a predetermined pH value such that said ²²⁵actinium accumulates during said first extraction step onto said first adsorbent whilst said first eluent has a pH value which is different from the pH value of the liquid target solution such that said ²²⁵actinium is eluted during said first elution step from said first adsorbent.

12. The method according to claim 10, wherein said first eluent (16) comprises a first acid solution which contains the same acid as said target solution, in particular nitric acid.

13. The method according to claim 10, wherein said first eluent (16) is circulated during said first elution step in a fourth closed loop (17) over a second extraction device (18) which comprises a second adsorbent onto which the ²²⁵actinium eluted from said first adsorbent by means of said first eluent accumulates during said first elution step, the method comprising a second elution step wherein at least part of the ²²⁵actinium which has been accumulated onto said second adsorbent is eluted therefrom by means of a second eluent (19), the second eluent (19) having in particular a pH value which is different from the pH value of said first eluent such that said ²²⁵actinium is eluted during said second elution step from said second adsorbent, the second eluent (19) comprising preferably a second acid solution which contains the same acid as said target solution, in particular nitric acid.

14. The method according to claim 13, wherein said first eluent (16) is circulated from said first extraction device (6) to said second extraction device (18) over a second radon filter (20), in particular a second activated carbon filter, to extract radon from said first eluent (16).

15. The method according to claim 13, wherein said second eluent (19) is circulated during said second elution step in a fifth closed loop (21) over a third extraction device (22) which comprises a third adsorbent onto which the ²²⁵actinium eluted from said second adsorbent by means of said second eluent (19) accumulates during said second elution step, the method comprising a third elution step wherein at least part of the ²²⁵actinium which has been accumulated onto said third adsorbent is eluted therefrom by means of a third eluent (24), the third eluent (24) having in particular a pH value which is different from the pH value of said second eluent (19) such that said ²²⁵actinium is eluted during said third elution step from said third adsorbent, the third eluent comprising preferably a third acid solution which contains the same acid as said target solution, in particular nitric acid.
